(19) United States
(12) Patent Application Publication
(10) Pub. No.: US 2025/0174003 A1
(43) Pub. Date: May 29, 2025

(54) METHOD AND SYSTEM FOR CLASSIFYING IMAGES, STORAGE MEDIUM, AND TERMINAL

(71) Applicant: Shanghai Midu Science and Technology Co., LTD., Shanghai (CN)

(72) Inventors: Ou KONG, Shanghai (CN); Yidong LIU, Shanghai (CN); Jun WANG, Shanghai (CN)

(73) Assignee: Shanghai Midu Science and Technology Co., LTD., Shanghai (CN)

(21) Appl. No.: 18/579,866

(22) PCT Filed: Aug. 16, 2022
(86) PCT No.: PCT/CN2022/112630

§ 371 Date: Jan. 17, 2024

(30) Foreign Application Priority Data
Aug. 10, 2022 (CN) 202210955787.1

(51) Int. Cl. G06V 10/764; G06V 10/74; G06V 10/75; G06V 10/772

(52) U.S. Cl. CPC G06V 10/764; G06V 10/751; G06V 10/761; G06V 10/772

(57) ABSTRACT

Method and system for classifying images, storage medium and terminal. The method includes: constructing an object vector retrieval library, storing object feature vectors and object names of stored objects; performing object detection on a to-be-classified image and obtaining an object image of a detected object contained in the to-be-classified image; performing image recognition on the object image of the detected object to obtain an object feature vector of the object image; and searching the object vector retrieval library for an object name of a first stored object of the stored objects whose object feature vector matches the object feature vector of the object image of the detected object, and using the object name of the first stored object as a category of the to-be-classified image. The present disclosure can accurately retrieve images and conveniently expand classification categories through object detection, image recognition, and feature vector retrieval.

### FIELD OF TECHNOLOGY

The present disclosure generally relates to the technical field of image classification, and in particular to a method and a system for classifying images, a storage medium and a terminal.

### BACKGROUND

Image classification is a process where different characteristics reflected in image data are used to distinguish between various types of targets. This involves using computers to analyze images quantitatively, assigning each pixel or region in an image to a certain category, which essentially replaces the need for human visual interpretation.

In related technology, classification datasets are typically used to train image classification models. Once these models are trained, they are then used for image classification. However, a model trained on a dataset with 1000 categories can only classify images into these 1000 categories. If there's a need to classify images into categories not included in these 1000, the model would need to be retrained. This leads to a few limitations with the existing image classification models:

(1) Every time a new image classification category is added, the models need to be retrained, but if the number of image classification categories is extremely large, for example, 100 million, it becomes impossible to retrain the models.

(2) The models cannot recognize multiple objects in an image and will only output a single category.

(3) The models' recognition of small objects in images is poor.

### SUMMARY

The present disclosure provides a method and a system for classifying images, a storage medium, and a terminal, which can accurately retrieve images and conveniently expand classification categories by utilizing object detection, image recognition, and feature vector retrieval.

The method for classifying images comprises: constructing an object vector retrieval library, wherein the object vector retrieval library stores object feature vectors and object names of stored objects; performing object detection on a to-be-classified image and obtaining an object image of a detected object contained in the to-be-classified image; performing image recognition on the object image of the detected object to obtain an object feature vector of the object image; and searching the object vector retrieval library for an object name of a first stored object of the stored objects whose object feature vector matches the object feature vector of the object image of the detected object, and using the object name of the first stored object as a category of the to-be-classified image.

As an example, constructing the object vector retrieval library comprises:
acquiring object images of the stored objects;
performing image recognition on the object images of the stored objects to obtain respective object feature vectors of the object images; and
obtaining respective object names of the object images of the stored objects; and storing the object names and the object feature vectors of the object images of the stored objects in a one-to-one correspondence manner.

As an example, the method further comprises updating the object vector retrieval library in response to a new object image;
wherein updating the object vector retrieval library comprises:
obtaining the new object image for image recognition, obtaining an object feature vector and an object name of the new object image; and
adding the object name and the object feature vector of the new object image to the object vector retrieval library.

As an example, performing object detection on the to-be-classified image and obtaining the object image of the detected object contained in the to-be-classified image comprises:
performing object detection on the to-be-classified image based on an object detection model to obtain an object position of the detected object contained in the to-be-classified image; and
obtaining the object image of the object by cropping the to-be-classified image based on the object position.

As an example, performing image recognition on the object image of the detected object to obtain the object feature vector of the object image comprises:
performing image recognition on the object image of the detected object based on a PP-LCNet image recognition model; and
outputting the object feature vector of the object image by the PP-LCNet image recognition model.

As an example, searching the object vector retrieval library for the object name of the first stored object whose object feature vector matches the object feature vector of the object image of the detected object comprises:
calculating a similarity between the object feature vector of the object image of the detected object and each of the object feature vectors of the stored objects in the object vector retrieval library,
wherein among the object feature vectors of the stored objects, the first stored object has the greatest similarity and is determined to match the object feature vector of the object image of the detected object; and
obtaining the object name of the first stored object from the object vector retrieval library.

As an example, the similarity is a cosine similarity.

The system for classifying images comprises: a construction module, an object detection module, an image recognition module, and a classification module;
wherein the construction module constructs an object vector retrieval library, and the object vector retrieval library stores object feature vectors and object names of stored objects;
wherein the object detection module performs object detection on a to-be-classified image and obtains an object image of a detected object contained in the to-be-classified image;
wherein the image recognition module performs image recognition on the object image of the detected object to obtain an object feature vector of the object image of the detected image; and
wherein classification module searches the object vector retrieval library for an object name of a first stored object of the stored objects whose object feature vector matches the object feature vector of the object image of the detected object, and uses the object name of the first stored object as a category of the to-be-classified image.

The non-transitory storage medium has a computer program stored thereon, wherein the program, when executed by a processor, implements the method for classifying images.

The terminal for classifying images comprises: a processor and a memory;
wherein the memory is configured to store a computer program;
wherein the processor is for executing a computer program stored in the memory to cause the terminal for classifying images to perform the method for classifying images.

The present disclosed method and system for classifying images, storage medium and terminal have the following beneficial effects:

(1) They can accurately retrieve images by leveraging object detection, image recognition, and feature vector retrieval.

(2) They allow for easy expansion of classification categories and do not impose a limit on the number of image classification categories.

(3) When expanding classification categories, the object detection model only needs training to recognize a single object, and there's no need to retrain the image recognition model; instead, what is needed is simply updating the feature vector retrieval library for the object, which simplifies the process and reduces the load on the system.

### BRIEF DESCRIPTION OF THE DRAWINGS

FIG. 1 is a flowchart illustrating a method for classifying images according to one embodiment of the present disclosure.

FIG. 2 shows a block diagram of a system for classifying images according to one embodiment of the present disclosure.

FIG. 3 shows a block diagram of a terminal for classifying images according to one embodiment of the present disclosure.

### REFERENCE NUMERALS

21 Construction Module
22 Object Detection Module
23 Image Recognition Module
24 Classification Module
31 Processor
32 Memory

### DETAILED DESCRIPTION

The embodiments of the present disclosure will be described below. Those skilled can easily understand disclosure advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape, and size of the components in actual implementation; during the actual implementation, the type, quantity, and proportion of each component can be changed as needed, and the components' layout may also be more complicated.

The present disclosure provides a method and a system for classifying images, a storage medium, and a terminal; they can accurately retrieve images by leveraging object detection, image recognition, and feature vector retrieval; they allow for easy expansion of classification categories, do not impose a limit on the number and size of objects to be detected, and therefore are highly practical.

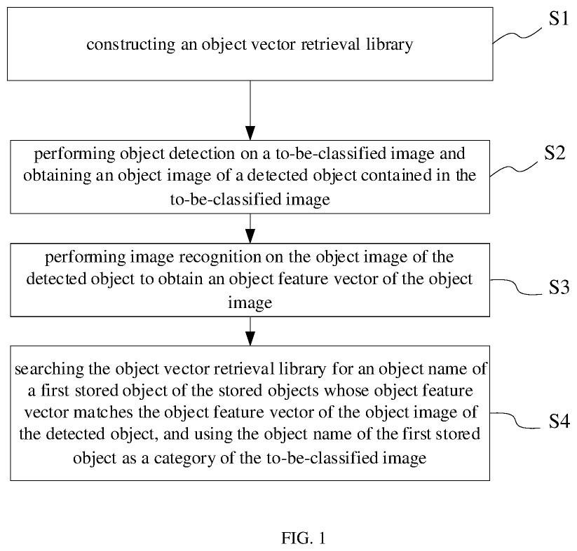

As shown in FIG. 1, as an example, the method for classifying images comprises steps S1-S4:

Step S1: constructing an object vector retrieval library, wherein the object vector retrieval library stores object feature vectors and object names of stored objects;

Specifically, S1 comprises:

11) acquiring object images of the stored objects.

Specifically, several object images are acquired. Each of the object images contains a single object.

12) performing image recognition on the object images of the stored objects to obtain respective object feature vectors of the object images.

Specifically, image recognition is performed on the object images of the stored objects based on an image recognition model. For example, a feature vector with 512 values can be obtained for each of the object images by the image recognition model. Assuming that there are 5000 object images, then a feature matrix with 5000*512 values can be obtained for the 5000 object images by the image recognition model. Preferably, Numpy and PP-LCNet are used to save the object feature vectors.

Preferably, the image recognition model is the PP-LCNet image recognition model open-sourced by PaddlePaddle.

13) obtaining respective object names of the object images of the stored objects.

Specifically, for each object image, a corresponding object name is obtained, such as Vehicle, Person, and Computer.

14) storing the object names and the object feature vectors of the object images of the stored objects in a one-to-one correspondence manner.

Specifically, the object vector retrieval library is constructed based on the object names and the object feature vectors, and the object names and the object feature vectors are stored in a one-to-one correspondence manner.

Step S2: performing object detection on a to-be-classified image and obtaining an object image of a detected object contained in the to-be-classified image.

Specifically, S2 comprises:

21) performing object detection on the to-be-classified image based on an object detection model to obtain an object position of the detected object contained in the to-be-classified image.

Specifically, the to-be-classified image is input into the object detection model to obtain the object position of the detected object contained in the to-be-classified image can be obtained; the object position may comprise object coordinates. There may be one or more objects detected by the object detection model. Preferably, the object detection model is PP-Picodet, an object detection network open-sourced by PaddlePaddle.

22) obtaining the object image of the detected object by cropping the to-be-classified image based on the object position.

The object image of the detected object is obtained by cropping the to-be-classified image based on the object position. When one object is detected, the object image of this one object is obtained by cropping the to-be-classified image; when two or more objects are detected, the object images of the two or more objects are respectively obtained by cropping the to-be-classified image

Steps S3: performing image recognition on the object image of the detected object to obtain an object feature vector of the object image.

Specifically, after inputting the object image into the PP-LCNet image recognition model, the object feature vector of the object image can be output.

Step S4: searching the object vector retrieval library for an object name of a first stored object of the stored objects whose object feature vector matches the object feature vector of the object image of the detected object, and using the object name of the first stored object as a category of the to-be-classified image.

Specifically, S4 comprises:

41) calculating a similarity between the object feature vector of the object image of the detected object and each of the object feature vectors of the stored objects in the object vector retrieval library,

For each of the at least one detected object, the similarity between the object feature vector of the object image of the detected object and each of the object feature vectors of the stored objects in the object vector retrieval library is calculated, Preferably, the similarity is a cosine similarity.

42) determining that the first stored object matches the object feature vector of the object image of the detected object, wherein among the object feature vectors of the stored objects, the first stored object has the greatest similarity.

43) obtaining the object name of the first stored object from the object vector retrieval library.

Specifically, the object name of the first stored object is used as a category (e.g., a label) of the to-be-classified image. When the to-be-classified image contains a plurality of object images, a plurality of corresponding categories is obtained.

As an example, when a new object image appears, a new category for images may be needed, at which time the object vector retrieval library needs to be updated. Specifically, updating the object vector retrieval library comprises steps a and b:

a) obtaining the new object image for image recognition, obtaining an object feature vector and an object name of the new object image.

For example, step a is performed based on the image recognition model.

b) adding the object name and the object feature vector of the new object image to the object vector retrieval library.

When performing image classification on the new object image, the object detection model of the present disclosure only needs to be trained for object detection of that new object image, and the image recognition model does not need to be re-trained, thus enabling rapid expansion of image classification without the need for fundamental algorithm updates.

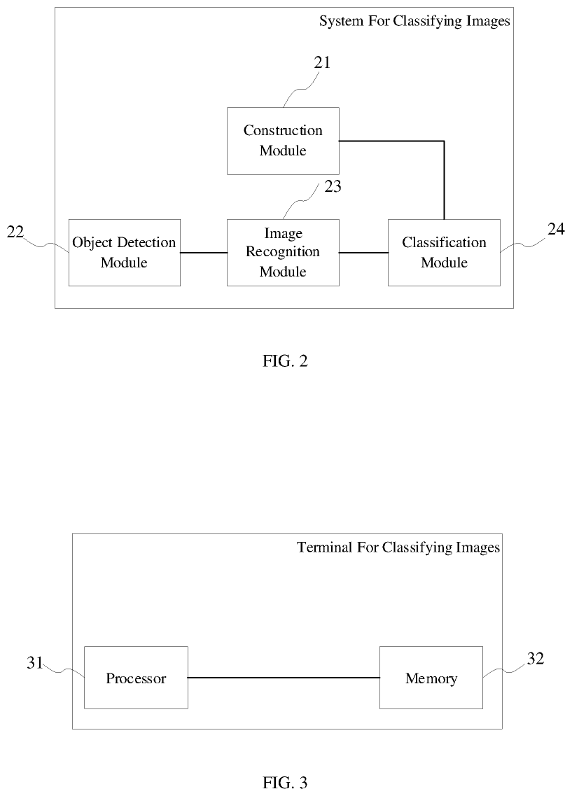

As shown in FIG. 2, as an example, the system for classifying images comprises a construction module 21, an object detection module 22, an image recognition module 23, and a classification module 24.

The construction module 21 constructs an object vector retrieval library, and the object vector retrieval library stores object feature vectors and object names of stored objects.

The object detection module 22 performs object detection on a to-be-classified image and obtains an object image of a detected object contained in the to-be-classified image.

The image recognition module 23 is connected to the object detection module 22 and performs image recognition on the object image of the detected object to obtain an object feature vector of the object image of the detected image.

The classification module 24 is connected to the construction module 21 and the image recognition module 23, and searches the object vector retrieval library for an object name of a first stored object of the stored objects whose object feature vector matches the object feature vector of the object image of the detected object, and uses the object name of the first stored object as a category of the to-be-classified image.

In an example, the structure and principle of the construction module 21, the object detection module 22, the image recognition module 23, and the classification module 24 correspond to the steps of the method for classifying images.

The present disclosure also provides a storage medium on which a computer program is stored; when the computer program is executed by a processor, the method for classifying images described above is realized.

It needs to be noted that it should be understood that the division of modules of the above device is only a logical function division, and the modules can be fully or partially integrated into a physical entity or physically separated in the actual implementation. In one embodiment, these modules can all be implemented in the form of software called by processing components. In one embodiment, they can also be all implemented in the form of hardware. In one embodiment, some of the modules can also be realized in the form of software called by processing components, and some of the modules can be realized in the form of hardware. For example, an x module may be a separate processing component, or may be integrated in a chip of the above-mentioned system. In addition, the x module may also be stored in the memory of the above system in the form of program code. The function of the above x module is called and executed by a processing component of the above system. The implementation of other modules is similar. All or part of these modules may be integrated or implemented independently. The processing elements described herein may be an integrated circuit with signal processing capabilities. In the implementation process, each operation of the above method or each of the above modules may be completed by an integrated logic circuit of hardware in the processor element or an instruction in a form of software. The above modules may be one or more integrated circuits configured to implement the above method, such as one or more Application Specific Integrated Circuits (ASICs), one or more Digital Signal Processors (DSPs), or one or more Field Programmable Gate Arrays (FPGAs). When one of the above modules is implemented in the form of calling program codes by a processing component, the processing component may be a general processor, such as a Central Processing Unit (CPU) or other processors that may call program codes. These modules may be integrated and implemented in the form of a system-on-a-chip (SOC).

The storage medium of the present disclosure has a computer program stored thereon which implements the above-described method for classifying images when executed by a processor. The memory may be a Read Only Memory (ROM), Random Access Memory (RAM), magnetic disk, flash disk, memory card, optical disk, or other non-transitory medium that can store program codes

As shown in FIG. 3, as an example, the terminal for classifying images of the present disclosure

The memory 32 is configured to store a computer program.

The memory 32 comprises one or more of a Read Only Memory (ROM), Random Access Memory (RAM), magnetic disk, flash disk, memory card, optical disk, or other non-transitory medium that can store program codes.

The processor 31 is connected to the memory 32 for executing a computer program stored in the memory to cause the terminal for classifying images to perform the method for classifying images.

Preferably, the processor 31 can be a general processor, comprising a Central Processing Unit (CPU), a Network Processor (NP), etc. It can also be a Digital Signal Processor (DSP) or an Application Specific Integrated Circuit (ASIC), a Field Programmable Gate Array (FPGA) or other programmable logic devices, discrete gates or transistor logic devices, discrete hardware components.

In summary, the present disclosed method and system for classifying images, storage medium, and the terminal can accurately retrieve images by leveraging object detection, image recognition, and feature vector retrieval, and allow for easy expansion of classification categories and do not impose a limit on the number of image classification categories; when expanding classification categories, the object detection model only needs training to recognize a single object, and there's no need to retrain the image recognition model; instead, what is needed is simply updating the feature vector retrieval library for the object, which simplifies the process and reduces the load on the system. Therefore, the present disclosure effectively overcomes various shortcomings of the prior art and has a high industrial value.

The above-mentioned embodiments are merely illustrative of the principle and effects of the present disclosure instead of restricting the scope of the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. A method for classifying images, comprising:
constructing an object vector retrieval library, wherein the object vector retrieval library stores object feature vectors and object names of stored objects;
performing object detection on a to-be-classified image and obtaining an object image of a detected object contained in the to-be-classified image;
performing image recognition on the object image of the detected object to obtain an object feature vector of the object image; and
searching the object vector retrieval library for an object name of a first stored object of the stored objects whose object feature vector matches the object feature vector of the object image of the detected object, and using the object name of the first stored object as a category of the to-be-classified image.

2. The method for classifying images according to claim 1,
wherein constructing the object vector retrieval library comprises:
acquiring object images of the stored objects;
performing image recognition on the object images of the stored objects to obtain respective object feature vectors of the object images; and
obtaining respective object names of the object images of the stored objects; and
storing the object names and the object feature vectors of the object images of the stored objects in a one-to-one correspondence manner.

3. The method for classifying images according to claim 1, further comprising updating the object vector retrieval library in response to a new object image;
wherein updating the object vector retrieval library comprises:
obtaining the new object image for image recognition, obtaining an object feature vector and an object name of the new object image; and
adding the object name and the object feature vector of the new object image to the object vector retrieval library.

4. The method for classifying images according to claim 1, wherein performing object detection on the to-be-classified image and obtaining the object image of the detected object contained in the to-be-classified image comprises:
performing object detection on the to-be-classified image based on an object detection model to obtain an object position of the detected object contained in the to-be-classified image; and
obtaining the object image of the object by cropping the to-be-classified image based on the object position.

5. The method for classifying images according to claim 1, wherein performing image recognition on the object image of the detected object to obtain the object feature vector of the object image comprises:
performing image recognition on the object image of the detected object based on a PP-LCNet image recognition model; and
outputting the object feature vector of the object image by the PP-LCNet image recognition model.

6. The method for classifying images according to claim 1, wherein searching the object vector retrieval library for the object name of the first stored object whose object feature vector matches the object feature vector of the object image of the detected object comprises:
calculating a similarity between the object feature vector of the object image of the detected object and each of the object feature vectors of the stored objects in the object vector retrieval library,
wherein among the object feature vectors of the stored objects, the first stored object has the greatest similarity and is determined to match the object feature vector of the object image of the detected object; and
obtaining the object name of the first stored object from the object vector retrieval library.

7. The method for classifying images according to claim 6, wherein the similarity is a cosine similarity.

8. A system for classifying images, comprising: a construction module, an object detection module, an image recognition module, and a classification module;
wherein the construction module constructs an object vector retrieval library, and the object vector retrieval library stores object feature vectors and object names of stored objects;
wherein the object detection module performs object detection on a to-be-classified image and obtains an object image of a detected object contained in the to-be-classified image;
wherein the image recognition module performs image recognition on the object image of the detected object to obtain an object feature vector of the object image of the detected image; and
wherein classification module searches the object vector retrieval library for an object name of a first stored object of the stored objects whose object feature vector matches the object feature vector of the object image of the detected object, and uses the object name of the first stored object as a category of the to-be-classified image.

9. A non-transitory storage medium having a computer program stored thereon, wherein the program, when executed by a processor, implements the method for classifying images according to claim 1.

10. A terminal for classifying images, comprising: a processor and a memory;
wherein the memory is configured to store a computer program;
wherein the processor is for executing a computer program stored in the memory to cause the terminal for classifying images to perform the method for classifying images according to claim 1.
